(19) United States
(12) Patent Application Publication
(10) Pub. No.: US 2014/0295389 A1
(43) Pub. Date: Oct. 2, 2014

(54) System for the Development of Communication, Language, Behavioral and Social Skills

(71) Applicant: SpecialNeedsWare, LLC, New York, NY (US)

(72) Inventors: Jonathan Izak, New York, NY (US); Ankit Agarwal, Cary, NC (US)

(73) Assignee: SpecialNeedsWare, LLC, New York, NY (US)

(21) Appl. No.: 14/044,503

(22) Filed: Oct. 2, 2013

Related U.S. Application Data
(63) Continuation of application No. 13/855,634, filed on Apr. 2, 2013.

(51) Int. Cl. G09B 5/02

(52) U.S. Cl. CPC G09B 5/02
USPC 434/236

(57) ABSTRACT

A software application for use with a computing device assists disabled individuals with communication, social, or language skills by providing hybrid displays that integrate scenes and hot spots therein with grids that display choices relating to the scene. The application can be location aware, displaying scenes relating to the current location. The application also can display a schedule of tasks that lead to the completion of a larger task. The application can also include an interface to create sentences, and an interface to create additional hotspots or schedules.

### BACKGROUND OF THE INVENTION

Autism spectrum disorders are a range of neural developmental disorders that are characterized by social deficits, communication impairments, behavioral deficits, and cognitive delays. The Center for Disease Control reports that 1 in 50 school aged children in the United States are diagnosed with autism as of 2012. About one third to half of individuals with autism do not develop enough natural speech to meet their daily communication needs. There is no known cure for autism.

Other intellectual and developmental disabilities, in addition to autism, include pervasive development disorder, cerebral palsy, down syndrome, fragile X syndrome, and other speech and language deficits. Individuals with these conditions also have difficulty with communication, language, behavioral and social skills. The majority of those with such intellectual or developmental disabilities lack social support, meaningful relationships, future employment opportunities, and the ability to live independently.

Augmentative and Alternative Communication (“AAC”) is an umbrella term that includes the methods used to complement or replace speech or writing for those who are impaired in the comprehension or production of spoken or written language. Grid based AAC is a type of aided communication that consists of presenting gestures, photographs, pictures, line drawings, letters and words, which can be used alone or in combination to generate communication messages such as full sentences, phrases, greetings, short thoughts, desires, questions or single words. These communication messages can consist of synthesized or recorded auditory output of the message, a visual representation of the message, or a combination of both.

In a grid based AAC system, communication symbols are presented in a grid format. Some common vocabulary organizations display graphical representations organized by spoken word order, frequency of usage or category. In a core-fringe vocabulary organization, the “core vocabulary”—words and messages that are communicated most frequently—appear on a “main page”—the first page in the vocabulary hierarchy that is typically the starting point of such vocabularies. The “fringe vocabulary” consists of words and messages used more rarely and words that are specific to particular users. The fringe vocabulary appears on other pages, subsequent grids, etc. Symbols may also be organized by category, grouping people, places, feelings, foods, drinks, and action words together. Other grid vocabularies are organized by categories or specific activities.

One style of visual output of messages created using AAC is a sentence bar. A sentence bar presents the visual representations selected by the user to draft the message in the order they are selected, forming a visual sentence. Audio output corresponding to individual visual selections may be output when they are added to the sentence bar. Commonly, tapping a speak button or the sentence bar itself will provide auditory output corresponding to the selections that are in the sentence bar. There is also commonly one or more buttons or other methods that allow users to delete or clear an item from the sentence bar.

Categories/Folders: These vocabularies can contain categories/folders that lead to other vocabulary pages when tapped. Images associated with categories may be added to the sentence bar when tapped. A button allows users to go to a previous vocabulary page.

Grid based AAC systems require the speech impaired user to have certain prerequisite language skills for their use. Firstly, users must understand the symbols or pictures that are being used to represent words and language concepts. For example, the user would need to understand the graphical representation of an “I Want” symbol in order to use that word for communication purposes. Even when using real photos to represent items or concepts, the speech-impaired user must learn the meaning of this image to use it within an AAC system for effective communication.

Visual Scene Displays are another type of AAC system. These AAC systems use larger images of real world settings and interactions that contain hotspots, or interactive areas of the display, sometimes represented visually, that can be touched to generate speech for communication purposes. These scenes represent communication concepts within the context of how they would be viewed in the real world. Research shows that young children and those with complex communication needs, such as autism, who do not posses language skills can gain the ability to use this type of communication system in less time than a grid based AAC system. The use of visual scene displays does not require the same prerequisite language skill as do grid based AAC systems.

The quantity of communication that can be produced using a visual scene display system is more limited than that of a grid based AAC system, as navigating such systems for vocabularies comprising of thousands of words would be highly inefficient. Therefore, visual scenes displays may fill the needs of those just learning to communicate but do not fill the needs of someone who acquires more complex communication abilities. On the other hand, grid based AAC systems allow for complex communication but are more challenging to learn. This can lead to slower acquisition of language for the speech impaired user or may be too challenging for the user to use for successful communication.

Accordingly, there is a need for a system that can be used by intellectually disabled individuals and their caregivers, which assists such individuals in the development and practice of communication that is easy for emerging communicators to learn and use for simple communication through visual scenes, while providing the capability to build upon these simple communication skills to progress towards more complex communication using a grid based AAC system.

There are a number of research-based visual aids that are used in various strategies to teach behavioral and social skills in these populations. Among the most researched and widely used of these visual aids are videos for video modeling, picture sequences and picture schedules, or visual schedules. Video modeling consists of showing videos of positive behaviors to be modeled. Picture schedules are used to display a visual sequence of a routine or social interaction for the purpose of teaching every day behaviors.

Visual schedules are a series of tasks represented by images. As tasks are completed, a visual indication can be made to represent the fact that the task is complete. These are used to with those with intellectual and developmental disabilities to allow them to

[symbol]

Since communication, behavioral skills, and social skills are required in everyday life activities, visual aids and communication aids are much more effective and practical on a mobile platform. Many of those with intellectual and developmental disabilities are not capable of independently navigating between applications purposed for each of these various needs on such a device. In addition, it is impractical for communication impaired individuals to lose access to their communication aid while using visual tools for other life skills.

Accordingly, there is a need for a mobile system that combines an effective communication system with the visual aids required for everyday activities and routines.

### FIELD OF INVENTION

The present disclosure is directed to providing devices, systems and methods for providing a sensory aid for the developmentally disabled.

### SUMMARY OF THE INVENTION

A system for social, behavioral, and communicative development is disclosed herein. The system includes a touch screen device such as a smart phone or a tablet computer, adapted to provide an interactive experience for an Autistic or developmentally disabled user whereby such user can enhance his or her social, behavior, and communicative skills through a series of iterative steps based on different stimuli in typical environments in which they find themselves. The system includes scenes and hotspots as defined herein. Scenes are images that fill the entire screen of the device. They depict a setting where the user may find himself in daily life, such as a room in a house, or a class room, or a store, or some other more abstract learning concept displayed pictorially or photographically. Hotspots are buttons (e.g., shapes, symbols or pictures) that are placed within the scene to make the scene interactive. For example, a kitchen scene could have hotspots for a refrigerator, a chair, a stove, etc. The hotspot creates interactivity where the participant can learn about and/or interact with the element of the scene associated with the hotspot as discussed in further detail below. The system further includes a hybrid choice board as disclosed in further detail herein, which includes a scene having one or more hotspots, overlaid partially, but not completely, by a categorical grid display and/or a sentence builder, permitting the disabled individual to interact with a series of choices, or build sentences, while still being exposed to part of the scene.

The system further includes visual schedules as described in further detail herein, whereby the system visually breaks down any sort of routine or habitual activity into components or smaller tasks to simplify the entire event into smaller, easier to follow steps so that users can better manage the daily events of their lives. The system further includes visual stories as disclosed in further detail herein, whereby the system sequences a story to instruct the user in how to complete a task by breaking it down into a sequence of simple actions, tell the story of something that transpired earlier, or demonstrate/educate the user to learn something new. The system further includes a grid display system with sentence builder as disclosed in further detail herein, permitting the disabled individual to build novel sentences that are not necessarily pre-programmed into the system by combining picture or symbol representations of words or phrases into a sentence.

### BRIEF DESCRIPTION OF THE DRAWINGS

The drawings presented herein are for the purposes of illustration, the invention is not limited to the precise arrangements and instrumentalities shown.

FIG. 1 is a flow chart of the GPS Tracking and Hybrid Choice boards functionality in accordance with an aspect of the present disclosure.

FIG. 2 is a flow chart of the functionality for creating and interacting with invisible drawn hotspots in accordance with an aspect of the present disclosure.

FIG. 3 is a flow chart for the functionality of accessing the visual schedule feature in accordance with an aspect of the present disclosure.

FIG. 4 is a flow chart of the functionality for associating video modeling and video/picture sequences with visual schedules in accordance with an aspect of the present disclosure.

FIG. 5 is a flow chart of the functionality for the use of visual schedules integrated into visual scenes in accordance with an aspect of the present disclosure.

FIG. 6 is a flow chart of the functionality for providing visual scenes, visual schedules, and Augmentative and Alternative Communication Grid Displays and/or Sentence Building in accordance with an aspect of the present disclosure.

FIG. 7 is a screen shot of the home screen in accordance with one aspect of the present disclosure.

FIG. 8 is a screen shot of location selection in accordance with one aspect of the present disclosure.

FIG. 9 is a screen shot of a scene in accordance with one aspect of the present disclosure.

FIG. 10 is a screen shot of a hybrid choice board without sentence builder in accordance with one aspect of the present disclosure.

FIG. 11 is a screen shot of a hybrid choice board with sentence builder in accordance with one aspect of the present disclosure.

FIGS. 12A and 12B are screen shots of two steps in a visual schedule process.

### DETAILED DESCRIPTION OF ONE ASPECT OF THE INVENTION

In accordance with one aspect of the invention, a touch screen computing device, such as an Apple iPad, another tablet, a computer touch screen, or a smart phone, contains a storage memory, such as a hard drive or flash memory. The storage memory contains computer readable instructions corresponding to a software application for use by the developmentally disabled person and his/her caregivers, to assist such developmentally disabled individuals in developing communication, social, and/or language skills of a type that are less easily developed by developmentally disabled people than by typically developing people.

The application presents users with visual scenes which include hotspots. A scene is a visual depiction (e.g., a photograph) of a location such as a store, a school, a home, or a room. A hotspot is an area of the scene which, when touched by the user, triggers further functionality as discussed below. In accordance with this aspect of the disclosure, such hotspots can be placed and fully customized by the caregiver to make the scene interactive. Hotspots are represented by text, shapes, symbols, photographs, graphics, or freeform closed shapes drawn by the caregiver. Such freeform shapes can be invisible, outlined, or outlined with a translucent fill. An invisible free form shape can permit a caregiver to transform an object shown in the scene into a hotspot. This allows for the ability to accurately make abstract objects interactive. However, the interactive object can be displayed without a “visual prompt,” which allows the disabled individual to initiate communication without the prompt of a caregiver or visual aid.

A choice board in accordance with the present disclosure is a pop-up window which overlays a scene and displays a grid of additional options that can then be selected to carry out a specific action. This action can include a voice, video, story schedule, or scene link output. These actions are visually represented by a button or folder that can have a text label and/or image within the choice board. A hybrid choice board in accordance with one aspect of the present disclosure is a choice board which is overlaid on top of the scene without fully obscuring it. The hybrid choice boards in accordance with this aspect of the disclosure are unique because they allow the disabled individual to perceive the choices in the context of the entire scene. The scene is still visible behind the choice board, which allows the disabled user to relate the visuals shown represented by the scene to the language or other options presented in the choice board. This is known as a “mixed-display,” or “hybrid display,” between two different alternative and augmentative communication formats known as a visual scene display and a grid display. A grid of options appear in a window that is smaller than the size of the entire scene so that the scene is visible around the window, for example, it is visible around at least 3 borders of the window. The window can include choosable options, such as objects which might be found in or around the location in the scene corresponding to the hotspot. For example, if the hotspot is a refrigerator, the options may include different food items that might be found in a refrigerator. By way of example, the user touching the food item on the screen can trigger a voice output saying the name of the food item and/or information about the food item.

In one aspect, the hybrid choice board can include a sentence building message window where either the disabled user or caregiver can select a combination of button and/or folder options in the choice board to build a basic sentence. A basic sentence typically consists of no more than one to three button/folder combinations. If the sentence builder is enabled, then the text label and image associated with each button will appear in the sequential order in the message window. If a folder is selected, this will bring you to another level of buttons/or further nested folders, and the selected folder may move into the sentence building message window but by default it does not do so. In one aspect of the present disclosure, this is an option that can be changed in the settings for the application. The folder or buttons can trigger a vocal output when selected.

In one aspect, the touch screen device on which the application is installed into memory also contains a global positioning system (GPS) chip, or any other location-aware technology. Scenes within the application are grouped by the location(s) in which they appear. The application may be equipped to receive the device's geographic location and present the user with one or more visual scenes relating to his or her current geographic location. Each scene within the application would be associated with a geographic location represented by a name. Default locations can include home, school, and/or other frequently visited locations in the community such as stores. Caregivers can also create new locations with custom names. Using geographic locations based on the disabled individual's environment is the default way to organize the scenes. This reduces the cognitive demands to operate the application by reducing the navigational requirements for the disabled individual, and thereby promotes independence for the disabled individual. Caregivers may choose to organize scenes by their geographic location as the default, or by any other common feature to the scenes. For example, instead of using a location of “My School” and presenting scenes related to school in this location, a caregiver can create a location of “Anatomy” and create scenes relating to learning human anatomy.

The application has an edit mode and a user mode. Edit mode is intended for the caregiver and allows content and features, including scenes, locations, choice boards, schedules, etc., within the application to be created, customized, renamed, and deleted. The customizations that can be applied to scenes include changing the scene image and adding hotspots to the scene. Edit mode also allows the user to access the in-application settings menu and the help menu. In one aspect of the invention, the application has a GPS setting that can be toggled on or off. In one aspect, a caregiver can set the GPS position of a location, e.g. by selecting the caregiver's current location as the location for a chosen scene.

Location menu: From within the application, the disabled individual or caregiver can manually change which location is presented by tapping the location menu in the top left corner. This menu contains a visual representation of each location that can be set by the caregiver. The default locations are represented by images.

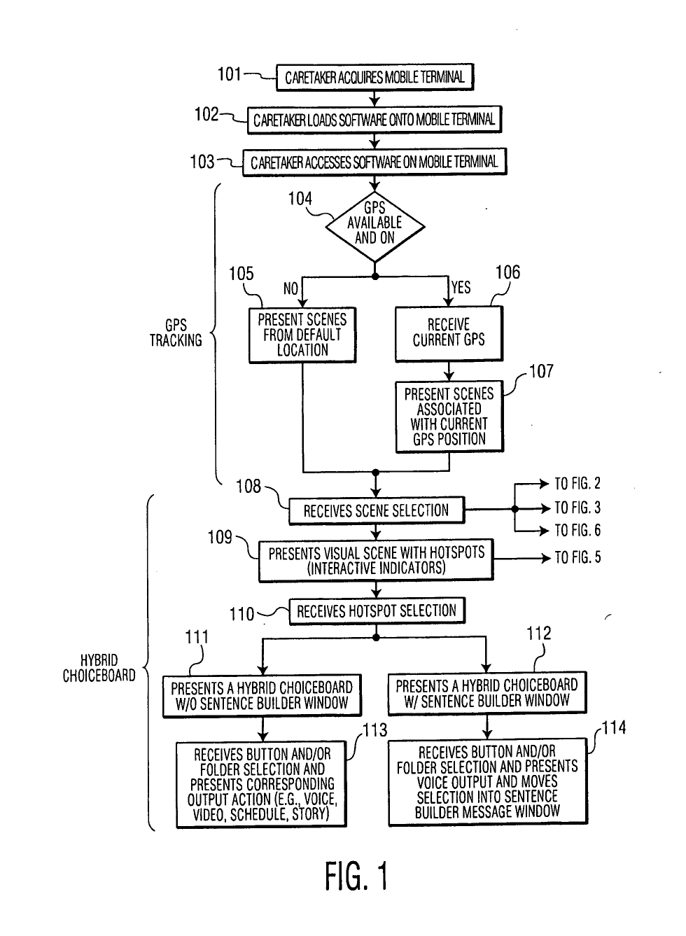

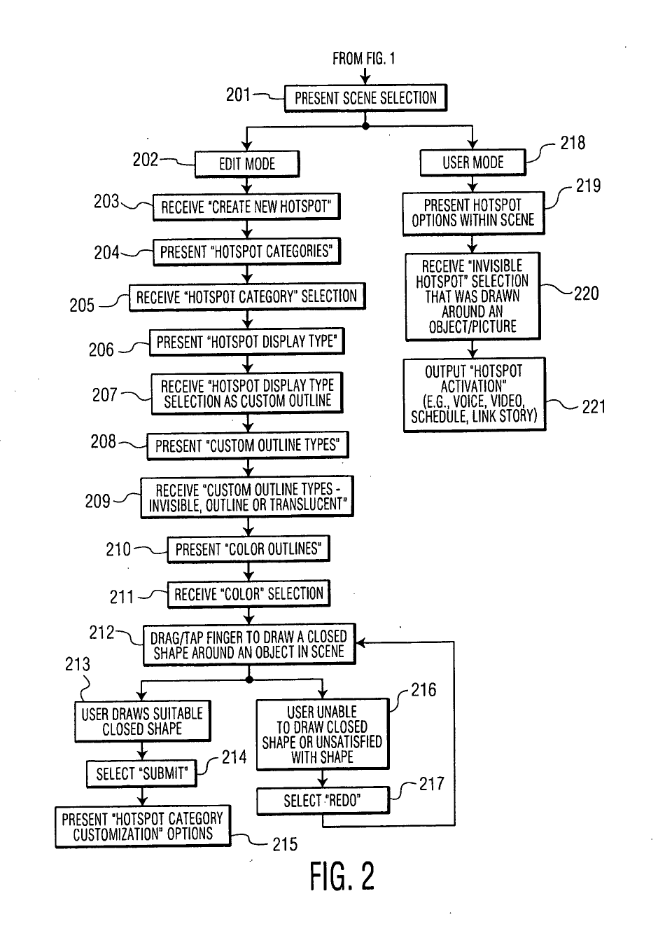

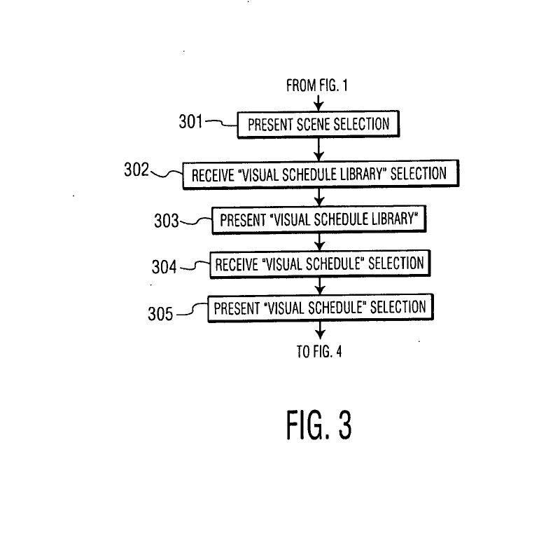

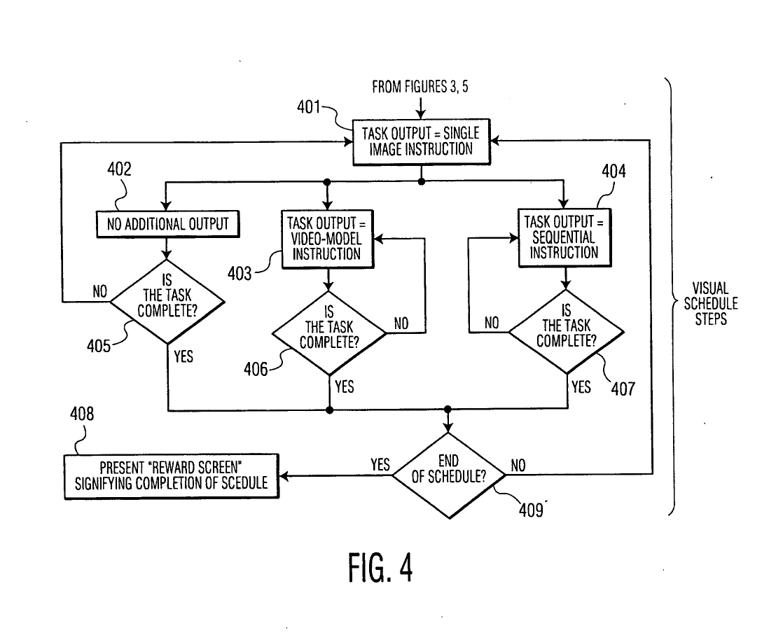

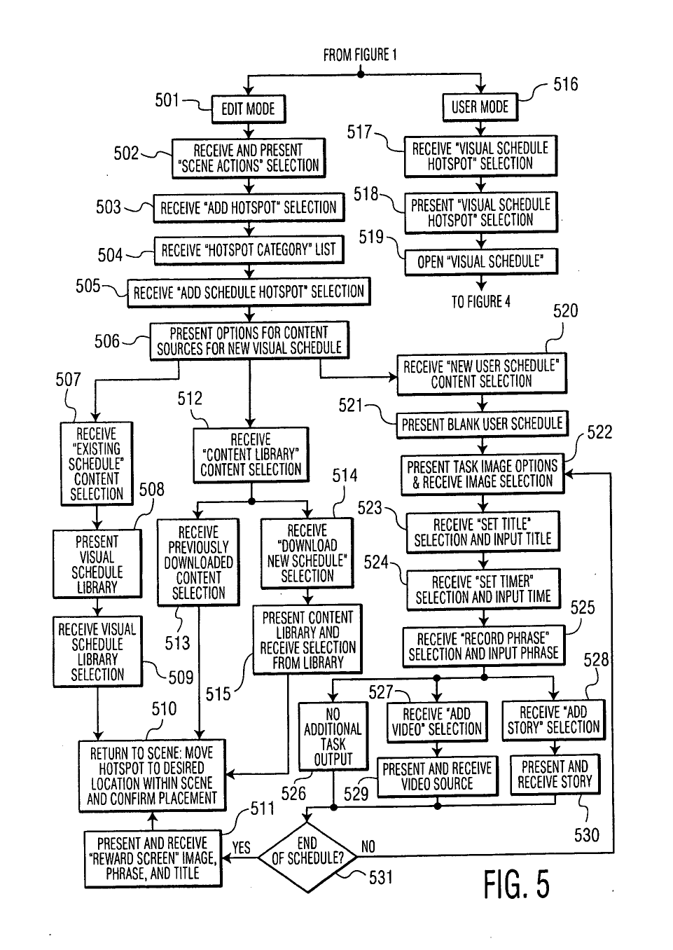

Turning now to FIG. 1, after the caregiver launches the application on the mobile terminal 103, the application determines if the devices has a GPS chip, and if the GPS feature is enabled in the application 104. If the GPS setting is off, the application presents the user with scenes from a default location 105. In another aspect of the invention, the application could present the user with scenes from the most recently accessed location. If the GPS setting is on, the software receives the current GPS position from the mobile terminal 106. If this is within a predetermined distance (e.g. 1,500 ft.) of one or more of the GPS positions associated with any location, the location with the nearest position to the current GPS position reported by the terminal is presented, as well as the scenes from that location 107.

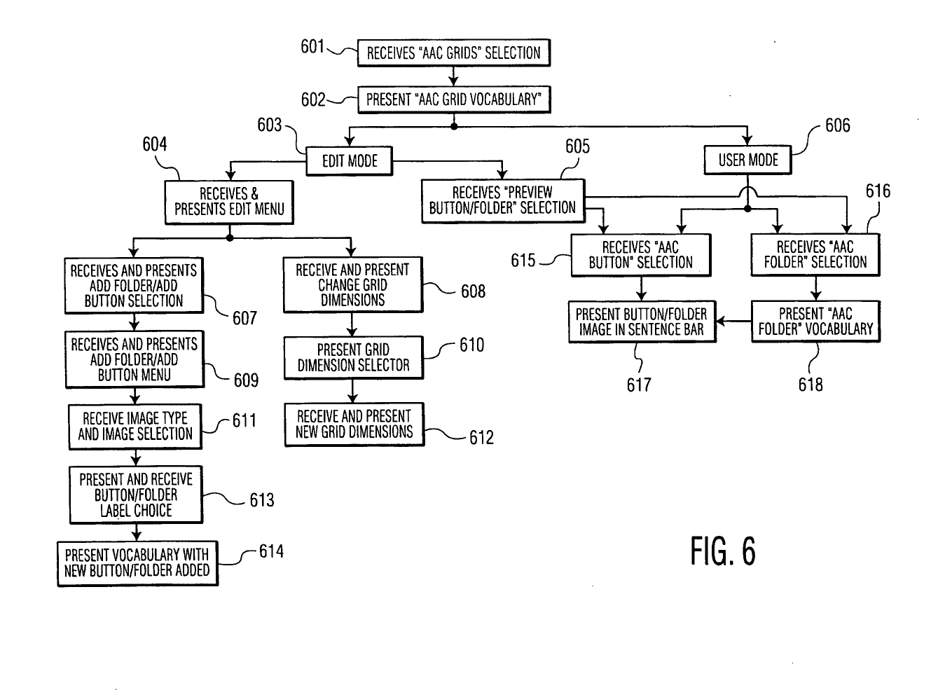

Once the scenes are presented, the user makes a scene selection 108. The selected scene may contain invisible drawn hotspots, or the user, if a caregiver, may wish to create invisible drawn hotspots. If so, the application moves to the functionality depicted in FIG. 2. Alternatively, or in addition, the scene may contain one or more visual schedules as discussed below and depicted in FIG. 3, which leads to the process depicted in FIG. 4. In any event, after the user is presented with a scene 109, the user can select a hotspot 110. The user may also be presented with, or may wish to create, visual schedules integrated into the visual scenes, as discussed below with reference to FIG. 5, which also leads to the process as depicted in FIG. 4. The user may also be presented with a sentence builder as depicted in FIG. 6. After the visual schedules aspect is either chosen or skipped, the selected scene can present a hotspot that opens a hybrid choice board, either without 111 or with 112 a sentence builder window. If the choice board is presented without a sentence builder window, the application receives button and/or folder selections from the user and presents corresponding output action 113. The action can include voice, video, pictures, a story, a link to another scene, or a schedule as discussed in accordance with FIGS. 3, 4 and 5 as discussed below.

The voice can be prerecorded or user-recorded, and it can, in one aspect of the disclosure, include variations of a phrase, which could be randomized to demonstrate the concept of using different phrases to convey the same idea or refer to the same concept. This is a difficult but important skill for the disabled individual, who may find it difficult to generalize different phrases to have the same language meaning. For example, these multi-variation recordings can be an effective teaching method for social communication—teaching, for example, variations of “Hi,” “How's it going,” “Hello,” “How are you,” etc. Multi-variation recordings are supported in other areas of the application and are not limited to just use within hybrid choice boards. Such other areas include voice hotspots, visual stories and visual schedules. Turning back to FIG. 1, if the choice board is presented with a sentence builder window, the application receives button and/or folder selection and presents voice output and moves selection into the sentence builder message window 114.

Turning now to FIG. 2, the flow chart for the functionality of the application if the scene contains, or if the user wishes to create, invisible hotspots is shown. If the application is in edit mode 202, the user may choose to create a new hotspot 203. The user makes a selection from a set of hotspot categories 204, and is asked how the hotspot should be displayed 206. These options can include a symbol, a photograph, shape or custom line drawing. The user can then choose “custom outline types” 208. The user may then choose an invisible, translucent, or outline hotspot 209. If the hotspot is not invisible, the user may choose a color for the outline of the drawn hotspot 211. The user is then asked to draw the shape 213. If the shape is drawn successfully, the user is presented with further customization options for the hotspot 216. If not 216, the user is asked to try again 217.

If the application is in User mode (as opposed to Edit mode) 218, the user is presented with hotspot options within the selected scene 219. These hotspot options can include a symbol, shape, photograph, or custom line drawing. In one aspect of the disclosure, the user may touch one or more hotspot areas on the touch screen device 220, which activates a variety of different hotspot outputs. These outputs can include a voice output, a schedule, a story, linking to another visual scene or no output. The hotspot area can also activate the hybrid choice board as discussed with reference to FIG. 1, and then performs the hotspot functionality of FIG. 1 221.

In one aspect of the present disclosure, visual schedules are used. A visual schedule breaks down any sort of routine or habitual activity into components or smaller tasks to simplify the entire event into smaller, easier to follow steps so that users can better manage the daily events of their lives. Each of these tasks is represented by a picture, and can also contain additional media and/or information for the user such as sequential instruction or video-model instruction. Sequential Instruction is a way to break down any activity into smaller sub-tasks through the use of a sequence of slides that will either contain short videos or pictures that are accompanied by short written sentences and corresponding audio. It is similar to a short picture book that can be used to instruct the user in how to complete a task by breaking it down into a sequence of simple actions, tell the story of something that transpired earlier, or demonstrate/educate the user to learn something new. These stories can be created by the user or downloaded from a content library.

Video-Model Instructions are created with the intent to train the user in how complete a task through the use of video-modeling. These videos usually talk to the user directly and go through the task step by step, with both visual representation/demonstration and with audio instruction, on how to accomplish a task or complete an activity of some sort. Single Image Instruction is the most basic way to represent a task in a visual schedule. A task in this case is represented by an image and possibly accompanied also by a short audio phrase or sentence. In one aspect of the present disclosure, multiple audio phrases can be recorded in each task and randomized to generalize the language concepts as discussed above. Each task is at the minimum represented with single picture instruction at a minimum, with the opportunity for the Caregiver to add additional media to the picture, such as sequential or video instruction.

A “task” is a step in a visual schedule. These schedules are broken into more simple tasks to make a schedule feel less onerous. Tasks can be given a time limit in which the task should be completed, referred to as a “Visual Timer”. This visual timer is overlaid on to the single picture instruction in such a way to visually represent the amount of time that is left. It is important to integrate the visual representation of the task with the task itself in order to provide an intuitive visual association that can be understood by the user with special needs between the amount of time left to complete the task and the timer itself. One such way that the timer is displayed is by covering the visual representation of the task with a colored translucent layer. Initially, the entire area of the image is covered by the translucent layer to represent full amount of time provided for the task is remaining. As the amount of time left to complete the task decreases, the proportion of the area of the task image covered by the translucent layer decreases to the same proportion of the amount of time left in the timer in a similar fashion to the way in which a hand moves on a clock. Alternatively, the image that represents the task can initially appear completely uncovered to represent that no time from the timer has elapsed. As the timer counts down, a colored translucent layer covers an increasing proportion of the task image to represent the proportion of time in the timer that has elapsed. After a task is completed, the user will tap in the small box below the visual representation of the task. A visible indication will appear in this box below the single image to acknowledge that it has been completed in order to move into the next task in the schedule. The caregiver can optionally chose alternative indicators such as a single-tap on the single image instruction rather than a box below to sequence to the next task. The task output is the media that is displayed to instruct the user on how to accomplish that task. This output can contain single picture instruction with the additional option to include audio, a visual timer, and/or either video or sequential instruction.

In one aspect of the invention, a reward screen appears once the final task in the visual schedule has been completed. This screen can represent compensation (if any) that the user will receive for being able to complete the schedule, which can incentivize and motivate the user to make a strong attempt to learn and complete the schedule. This can be in the form of a picture and/or audio representation of the incentive. The end of the schedule is after the final task of the schedule is completed. Once the end of schedule is reached, the reward screen (if there is one) will appear.

Turning now to FIG. 3, within a visual scene, the User can access the Visual Schedule Library by clicking on an on-screen indicator. This will bring up a list of all of the visual schedules that the user has created or that have been downloaded from the content library for immediate use 302. The user then picks the desired visual schedule from the list that is presented in the Visual Schedule Library 303. If the software application is in edit mode, the caregiver will have the opportunity to create and/or edit visual schedules to fit the current needs and situation of the user. The Caregiver can test how any feature will respond in user mode by double tapping the feature in edit mode. Once a visual schedule is selected 304, the visual schedule will open and the first task will immediately be displayed for the user to see 305. As discussed above, what appears can include pictures, video, or audio of the task. The application then continues to the procedure depicted in FIG. 4.

Turning now to FIG. 4, In step 401, each task will have an minimum a basic visual representation of the task. This will be a picture or symbol that best represents that task so that the task can be visualized by the user. This image can also be accompanied by an audio segment that also helps the user figure out what is the task that needs to be accomplished. This image may also be accomplished by a visual timer that will give the user a set amount of time to accomplish the task once the image instruction has begun. Some tasks may not have any additional output in addition to the initial single image instruction and accompanying audio segment 402. For other tasks, after the single image instruction has been displayed, if there is accompanying video-model instruction for this task, that will appear shortly after 403. Video-Model instruction are created with the intent to train the user in how complete a task through the use of video-modeling. These videos usually talk to the user directly and go through the task step by step, with both visual representation/demonstration and with audio instruction, on how to accomplish a task or complete an activity of some sort. The disabled individual can then imitate the visual demonstration to learn how to carry out the particular task.

For still other tasks, after the single image instruction has been displayed, if there is accompanying sequential instruction for this task, it will appear shortly thereafter 404. Sequential instruction is a way to break down any activity into small pieces through the use of a sequence of slides that will either contain short videos or pictures that are accompanied by short written sentences and corresponding audio. It is similar to a short picture book that can be used to instruct the user in how to complete a task by breaking it down into a sequence of simple actions, tell the story of something that transpired earlier, or demonstrate/educate the user to learn something new. These stories can be created by the user or downloaded from a content library.

After all of the output for a task has been displayed, after the user has completed the task, they will tap on the screen to signify that the task is accomplished 405, 406, 407. This will result in a change in the screen display, such as a checkmark covering that small box. The image for the following task will, in one aspect, then become unfaded (all images for tasks that have yet to begin are pre-set to be faded and grayed out) to represent the fact that it is time to move on to the next task. If the task has not been completed, the user can tap the single image again, which will cause the task output for that task to begin again. If the task that has just been completed is the final task of the schedule 409, then the reward screen will appear 408. If not, then the next task will begin. The reward screen appears once the final task in the visual schedule has been completed 408. This screen should represent the compensation (if any) that the user will receive for being able to complete the schedule, mean to incentivize and motivate the user to make a strong attempt to learn and complete the schedule. This can be in the form of a picture and/or audio representation. In one aspect of the invention, each task can be associated with an on-screen timer that overlays the single step instruction to communicate to the user a predetermined length of time during which the task must be completed. The timer can be displayed in an analog clock style, wherein the task picture changes color, from faded to less faded, in stages over time, in proportion to how much time has elapsed and/or how much time is remaining.

A Visual Schedule Hotspot can be integrated within the framework of a visual scene. Every scene will have a universal visual schedule library located on the bottom right of the screen. Entirely separate from this are visual schedule hotspots that are specially created for certain scenes only. These visual schedule hotspots are placed within a scene at places/objects that are related to the schedule in order to encourage the user to utilize these schedules for certain tasks. This contextualizes the visual schedule by using the visual cues provided by the visual scene. This can be important for a disabled individual with cognitive language deficits and who does not have the capabilities to access the necessary schedule from the global list that is represented by text and/or isolated images. However, with the contextual reinforcement the individual is able to select the appropriate hotspot and then display the corresponding appropriate visual schedule. This promotes independence from a caregiver and also can teach categorization or relationships between similar language concepts.

Turning now to FIG. 5, which sets forth the procedure for the user of visual schedules integrated into visual scenes. When the software application is in User Mode 516, it is impossible to make any changes to any of the content that is contained within the application. The User can access and utilize any of the features but cannot make any changes. This is done to prevent any accidental changes and/or deletion of content that has previously been manually created, organized, and/or customized to fit the unique situation of that user. A visual schedule hotspot is selected by tapping an indicator within a scene such as a star with numbers or any other shape, symbol or custom line drawing. This will open up a visual schedule that is related to its location within the scene.

Edit mode 501 is intended for the caregiver and allows scenes and hotspots within a scene within the application to be created, customized, renamed, and deleted. Edit mode also allows the user to access the in-application settings menu and the help menu. The scene actions menu 502 is opened by tapping a visual indicator in the scene and will allow the caregiver to create a hotspot or change the background image of the scene 503. In this instance, it will be utilized to add a hotspot. The caregiver selects the add hotspot option of the scene actions menu, which opens up a list of the various types of hotspots that can be added into the scene 504. The caregiver selects the Visual Schedule hotspot from the menu 505, and then presents with hotspot icon display options such as a shape or symbol. Once the icon display type is selected, the hotspot is placed in the exact middle of the scene as a default/initial location. The Caregiver is then presented with the options for how to create the visual schedule 506: An existing schedule that has been previously created 507, a schedule from the content library 512, or a new user created schedule 520.

If the caregiver selects existing schedule 507 the caregiver is presented with the visual schedule library that contains all of the visual schedules that have been created previously through the visual schedule library 508. The Caregiver selects the desired schedule from the library and then this schedule is now also in the newly created hotspot 509. If the caregiver selects to create this schedule from the content in the software application's content library 512, the caregiver can select to utilize content that has been previously downloaded from the content library 513. If the caregiver selects to download a new schedule from the content library 514, the content library opens up upon selection and the user chooses a schedule from the content library 515. The schedule is downloaded upon selection and inputted into the new schedule hotspot 510.

If the caregiver selects to create a new schedule not based on a previous schedule 520, a blank schedule is presented with the first task of the schedule ready to have content inputted into it 521. When a new, blank task is presented, the user first may choose an image to represent the task within the visual schedule 522. Then the caregiver can set a title 523 and an optional timer 524 for the schedule. The user can then input a phrase that will be heard when the task is chosen 525. For the phrase, the caregiver can record a phrase or use a synthesized voice to recite the phrase. The caregiver can decide to not add any additional output that will be associated with this task in schedule 526. The caregiver can add video to the task that will open up when this task is selected 527, in which case this task will now utilize video-modeling to demonstrate to the user how to complete the task 529. This video can be from the content library, or be user generated. The caregiver can add a story to the task that will open up when this task is selected 528. This task will now utilize a sequential story to demonstrate to the user how to complete the task by breaking into its sub-steps. This sequential instruction or story can be from the content library, or be user generated 530. If the caregiver is satisfied with all the tasks within the schedule, and feels as though the schedule is complete 531, then a reward screen will now have to be created 511. If not, additional task(s) will be added by the caregiver 522. The reward screen, as discussed above, appears once the final task in the visual schedule has been completed 511.

After completing the schedule, the caregiver returns to the scene 510. The new hotspot will visually signify that its location within the scene has yet to be confirmed. The caregiver will place the new hotspot in the appropriate location within the scene and then confirm its placement by tapping the large green checkmark located in the bottom left of the scene.

In one aspect of the disclosure, visual scenes, visual schedules, and AAC grids can be displayed and used in a single platform. Turning now to FIG. 6, the process for using visual scenes, visual schedules and AAC grids to be used in a single platform is shown. The caregiver and/or disabled individual is shown a button that gives access to the AAC grids from within the scene selection screen, the visual scene screen, and the visual schedule screen 601. Tapping this button presents the AAC grid screen to the caregiver and/or disabled individual 602. This screen consists of a sentence builder at the top of the screen, a grid of buttons that may contain graphical representations and/or descriptive labels, a button to return to the screen of the application from which the AAC grid button was pressed, a button to clear the items in the sentence bar or delete the last symbol added to the sentence bar and a button to take the user back to the previous page, and a button to toggle edit mode. If the user is currently in edit mode, there is also a button to access the “edit grids menu.” This allows for the most efficient and simple navigation to a sentence-builder at any time. Because all possible communication utterances cannot be pre-programmed into the application, the ability to quickly navigate to a sentence-builder allows the disabled individual to expressively communicate a novel sentence by constructing a sequence of words/phrases. This unique combination of visual scenes, hybrid choice boards and an AAC grid display screen also allows the disabled individual to progress from the simplest and most intuitive forms of communication (a visual scene) to more complex sentence building (AAC grid display). The ability to quickly and efficiently access these various communication formats is important to allow the disabled individual to transition this person's language skills and communication abilities.

In user mode 606, the content of a grid vocabulary cannot be altered. Buttons and folders cannot be added to the vocabulary and the images, labels, and audio output associated with buttons and folders cannot be changed. While in user mode, if a user taps on a folder 616 the audio output associated with folder is emitted and the image and label for the folder may be added to the sentence builder 618. The page associated with that folder is also presented. If while in user mode a user taps on a button 615 the audio output associated with that button is emitted and the image and label associated with the button is added to the sentence bar 617. In one exemplary user interface, users can clear the sentence bar by tapping and holding on the delete button of the sentence bar or tap the delete button without holding to remove the last item added to the sentence bar that is currently in the sentence bar, if one exists. Tapping the back button will bring the user to the previously visited page of the vocabulary, if such a page exists.

In edit mode 603, caregivers can adjust the vocabulary by adding a button or folder to the current page of the vocabulary, or changing the image, audio output, or label associated with an existing button within the vocabulary. Tapping on the “Edit Menu” button presents the user with the edit menu 604. This menu contains options that allow users to edit the current vocabulary by adding a button, adding a folder, or changing the grid dimensions 607, 609.

If a user selects add button or add folder, the user is presented with options to select the type of image associated with the button or folder 611. This can be a symbol from the symbol library, a photo from the users photo library, from online photo databases or other locations, or an image taken using the device's camera. After selecting an image for the button/folder, users are prompted to enter a text label associated with the button/folder 613. This button/folder is added to the end of the last row of the current vocabulary page. This button/folder displays the selected image and the text label. The audio associated with this button is set to the currently enabled synthesized voice. After a new Button/Folder is complete, the vocabulary is presented with the new additions included 614.

If a user selects the change grid dimensions option from the customize grids menu 608 the user is presented with a grid dimension selector 610. This selector allows the user to set the number of rows and the number of columns in the current grid vocabulary. Once a user sets the number of grids and the number of columns and taps submit, the user is presented with the current vocabulary with adjusted numbers of buttons/folders on each page 612.

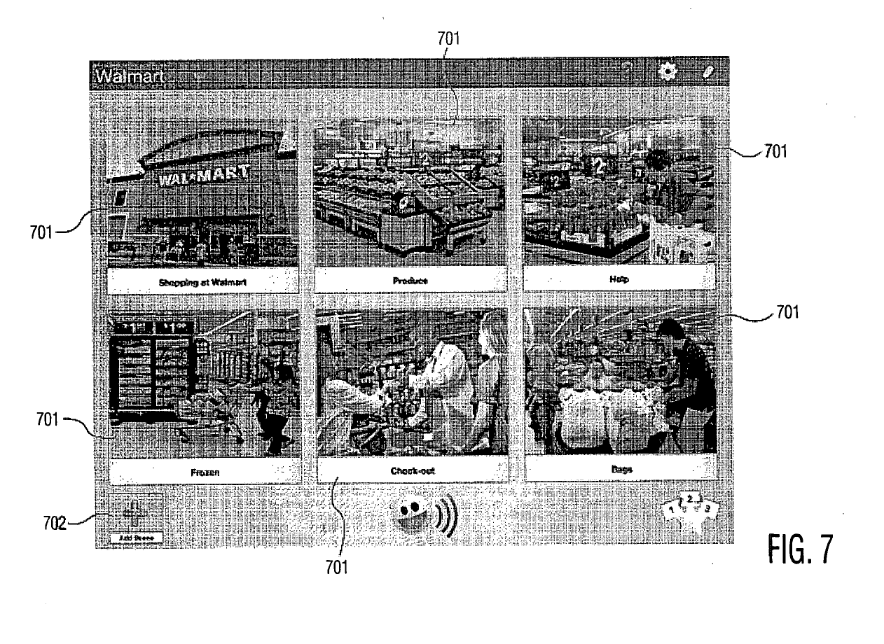

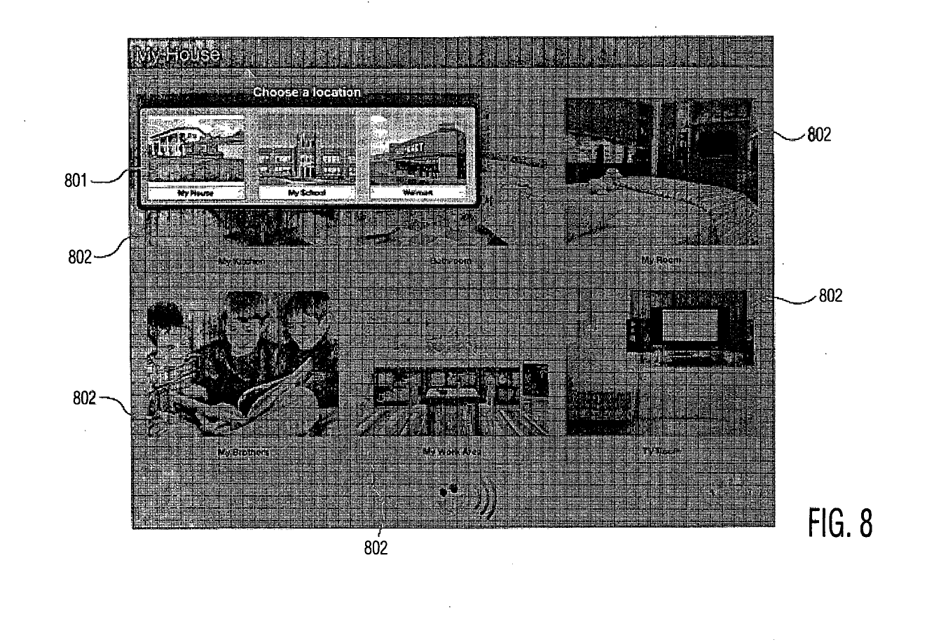

Turning now to FIG. 7, a representation of a screen from the application in the present disclosure. FIG. 7 shows the “home screen” of the application, including six touchable objects 701 corresponding to activities and things related to a Wal-Mart store. FIG. 7 demonstrates that the application is in “Edit Mode” allowing the caregiver to add scenes via button 702. In User Mode button 702 is not present. FIG. 8 shows the scene selection interface 801, where different locations can be chosen, and different scenes 802 for each location can then be chosen. The example in FIG. 8 shows a location of “My House,” including scenes 802 for “My Kitchen,” “Bathroom,” “My Room,” “My Brothers,” “My Work Area,” and “TV Room” are available for selection.

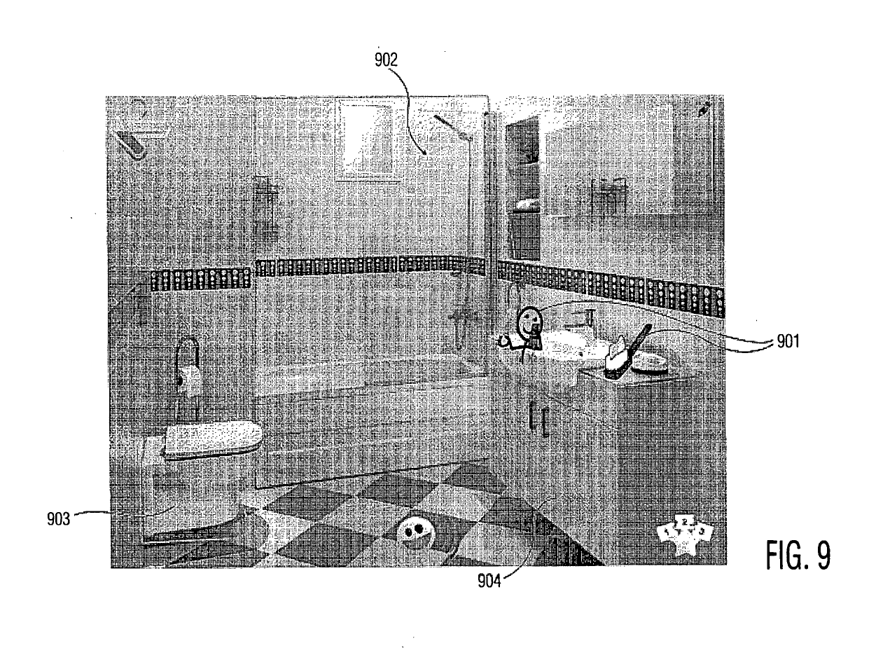

Turning now to FIG. 9, a scene is displayed. The displayed scene is a photograph of a bathroom. Symbol hotspots 901 display indicators for washing your face and brushing your teeth. When selected these hotspots can launch a visual schedule demonstrating the steps of these basic activities of daily living. A custom outline hotspot displaying an outline 902 is drawn around the shower. A custom outline hotspot displaying a translucent fill 903 is drawn around the toilet. An invisible custom outline hotspot 904 is drawn around the cabinets under the sink in a similar way to 902 and 903, but cannot be visibly seen because it is invisible.

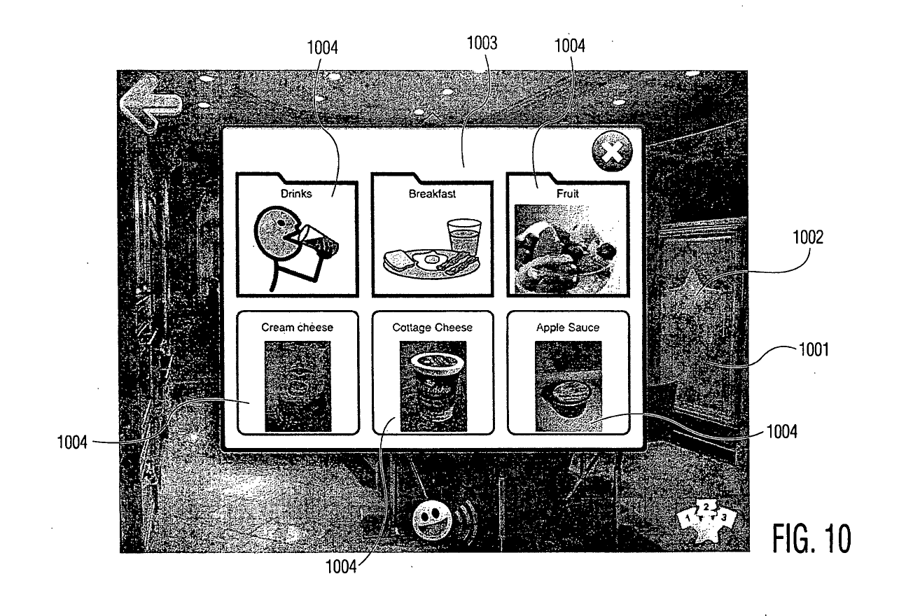

FIG. 10 shows a scene of a kitchen with a hybrid choice board selected. In the background of FIG. 10 is a photograph of a kitchen, including a refrigerator 1001. A hot spot symbol 1002 is on the door of refrigerator 1001 in the shape of a star, indicating that refrigerator 1001 is a hot spot. Once the hot spot symbol 1002 is touched by the user, choice board 1003 is displayed. Choice board 1003 includes option buttons 1004 which provide for the interactivity relating to different items found inside a refrigerator such as refrigerator 1001. The perimeter of the photograph of the kitchen remains visible while the choice board 1003 is displayed, to contextually represent that the user is in the setting of the kitchen. As discussed above, the user chooses an item, which results in either audio, video, and/or graphic feedback about the item, which can include a voice speaking the name of the item. Additionally, the selection of an item can link to another scene, launch a visual schedule, launch a visual story, or launch a video model.

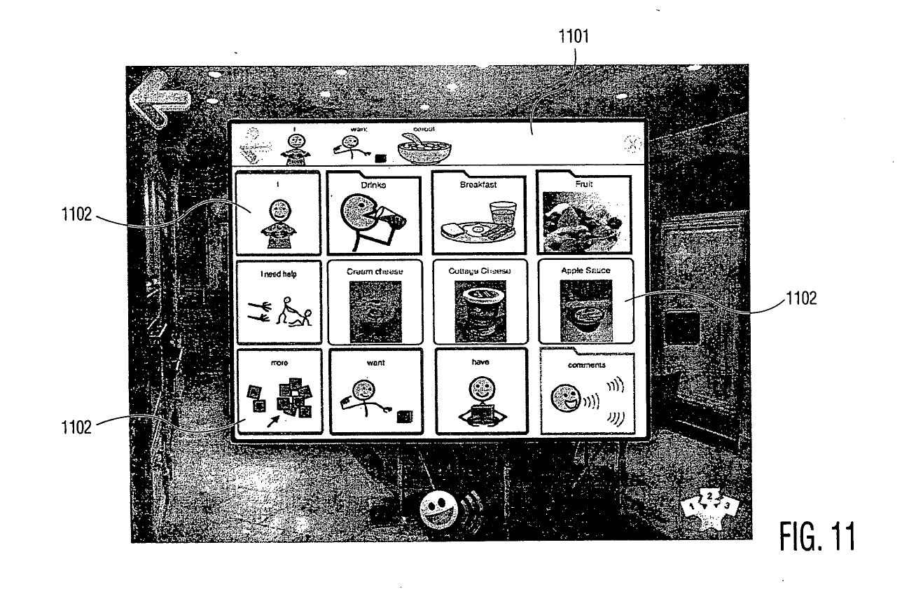

FIG. 11 shows a scene of a kitchen with a hybrid choice board selected as in FIG. 10 as displayed in the application of one aspect of the present disclosure. The choice board 1101 in FIG. 11 contains a sentence builder. The sentence builder includes buttons 1102 for various parts of speech and objects that permit the user to build a sentence such as “I want breakfast” or “I have fruit.” As in FIG. 10, the choice board 1101 in FIG. 11 does not fully obscure the photograph of the kitchen scene, which his still visible behind it to contextually represent that the user is in the kitchen setting.

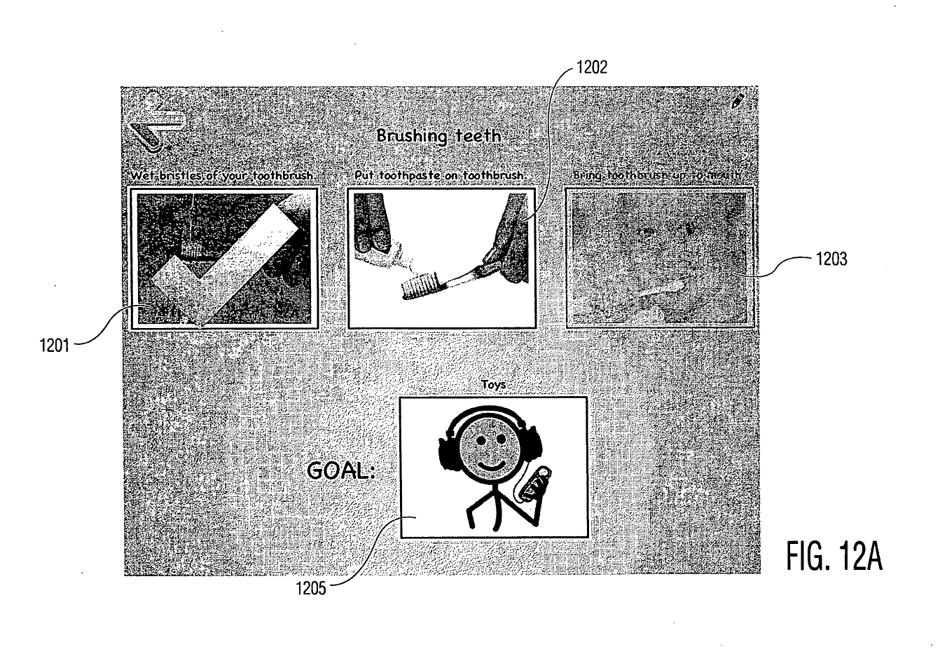

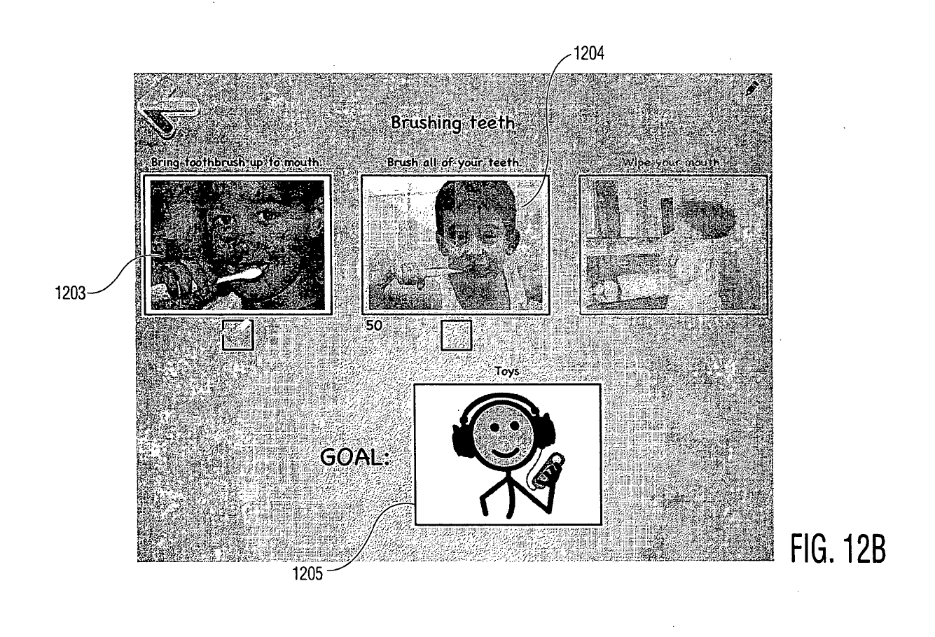

FIGS. 12A and 12B show the progress of a visual schedule in accordance with one aspect of the present disclosure. FIGS. 12A and 12B show the steps for brushing teeth, including some of the intermediate steps of wetting bristles on a toothbrush 1201, putting toothpaste on a toothbrush 1202 and bringing toothbrush to mouth 1203. In FIG. 12A, the first two tasks 1201 and 1202 are at full brightness, while the third task 1203 is faded. This indicates that the first two tasks 1201 and 1202 are completed while the third task 1203 is not yet completed. In FIG. 12B, third task 1203 has been completed. Also shown in FIG. 12B is a timer 1204, which counts down how long the task should take in seconds, so that the user knows how long to perform the task, which in this case is brushing his or her teeth. A visual timer also overlays the single step instruction in this step, as is shown from the different shading of the different parts of time 1204 in the style of an analog clock. Reward box 1205 is also shown in FIGS. 12A and 12B, to indicate to the user that he or she will receive compensation if he or she completes all the steps of brushing his or her teeth.

As discussed above, voice output can be programmed in several different areas within the application. Hotspots within scenes can be selected to activate a voice output. Buttons/folders within hybrid choice boards or AAC grids can also be selected to activate a voice output. While in edit mode, a caregiver can record multiple voice outputs to a single interactive object. These voice outputs can either be synthesized with a text to speech voice engine or recorded manually. When activated in user mode by the caregiver/disabled individual, the voice output will be randomized. This promotes generalization for the disabled individual by teaching variations of the same communication or language concept. For example, a single hotspot may output, “May I have a banana” and “I would like a banana.”

Persons having skill in the art will realize that the invention can be adapted beyond the specific steps and interface elements set forth herein, and that small variations in method steps, user interfaces, or other aspects of the invention, including omission of certain method steps, can be immaterial. Persons having skill in the art will realize that the invention can be practiced with a general purpose computer instead of a touch screen portable device without deviating from the scope of the invention.

1. (canceled)

2. (canceled)

3. The system of claim 5, wherein said choice board is a polygonal shape where at least two sides of said polygonal shape are shorter in length than two corresponding sides of the visual depiction.

4. The system of claim 5, wherein said method further comprises, after step d), the step of displaying a choice as a representation of a part of a sentence in a sentence builder based on said second input.

5. A system for enhancing communication, behavioral or social skills of a user, comprising a computing device, said computing device comprising a memory, said memory comprising machine readable instructions to enable said computing device perform a method comprising the steps of:
a) providing a visual depiction of a scene containing an object within the scene;
b) receiving first input from the user including a selected user interface object
c) in response to said user input, displaying a choice board comprising one or more choices contextually relating to the selected user interface object, wherein said choice board does not fully obscure said visual depiction;
d) receiving second input from the user including a selected choice from said choice board;
e) providing a first output from the group consisting of text, audio, graphic, video, story, and schedule, based on the selected choice; and
f) presenting a human useable interface for editing said visual depiction wherein said interface for editing includes interfaces for:
i) choosing an additional object in edit mode; and
ii) choosing an additional output to be associated with said additional object in edit mode.

6. The system of claim 5 wherein said object within said scene is displayed visually as a symbol from the group consisting of a text, a shape, a graphic, a free form drawing, and a photograph.

7. A system for enhancing communication, behavioral or social skills of a user, comprising a computing device, said computing device comprising a memory, said memory comprising machine readable instructions to enable said computing device perform a method comprising the steps of:
a) providing a visual depiction of a scene containing an object within the scene;
b) receiving first input from the user including a selected user interface object; and
c) presenting a human useable interface for editing said visual depiction wherein said interface for editing includes interfaces for:
i) choosing an additional object in edit mode;
ii) choosing an additional output to be associated with said additional object in edit mode
iii) accepting second input in the form of a free form drawing of a closed geometric shape having a location on said visual depiction, in edit mode; and
iv) accepting user input associated with said free form drawing when said user actuates said location, without displaying said free form drawing, when not in edit mode.

8. A system for enhancing communication, behavioral or social skills of a user, comprising a computing device, said computing device comprising a memory, said memory comprising machine readable instructions to enable said computing device perform a method comprising the steps of:
a) providing a visual depiction of a scene containing an object within the scene;
b) receiving first input from the user including a selected user interface object;
c) presenting a human useable interface for editing said visual depiction wherein said interface for editing includes interfaces for:
i) choosing an additional object in edit mode; and
ii) choosing an additional output to be associated with said additional object in edit mode
d) determining a geographic location of said computing device;
e) determining if one or more scenes are associated with said location;
f) if one scene is associated with said location, displaying a visual depiction of said associated scene, said visual depiction comprising one or more objects;
g) if more than one scene is associated with said location,
(i) providing a display for the selection of a scene by the user from said more than one scenes associated with said location;
(ii) displaying a visual depiction of said selected scene, said visual depiction comprising one or more objects
h) receiving from the user a selection of a selected object from the one or more objects; and
i) providing a first output from the group consisting of audio, graphic, video, story, and schedule, based on the selected object.

9. A system for enhancing communication, behavioral or social skills of a user, comprising a computing device, said computing device comprising a memory, said memory comprising machine readable instructions to enable said computing device perform a method comprising the steps of:
a) providing a visual depiction of a scene containing an object within the scene;
b) receiving first input from the user including a selected user interface object;
c) presenting a human useable interface for editing said visual depiction wherein said interface for editing includes interfaces for:
i) choosing an additional object in edit mode; and
ii) choosing an additional output to be associated with said additional object in edit mode
d) in response to said first user input, providing an output comprising a visual schedule comprising a series of choices corresponding to a series of smaller tasks wherein said smaller tasks, when performed in the order presented, result in the performance of said first larger task, and wherein said choices, upon actuation, visually depict that they have been completed.

10. (canceled)

11. The system of claim 9, wherein at least one of said series of choices comprises a visual representation having a first shade and a second shade, wherein said visual representation is represented in said first shade and said second shade, in proportion to an amount of time associated with said smaller task.

12. The system of claim 9 further comprising a visual depiction of a reward for completing said first larger task.

13. (canceled)

14. The system of claim 9, wherein said method further comprises the steps of presenting a human useable interface for editing said visual depiction comprising the steps of:
a) choosing an additional object;
b) associating said object with said first larger task or a second larger task; and
c) associating at least one new smaller task with said first larger task or said second larger task.

15. The system of claim 9 further comprising machine readable instructions for providing a human useable interface for creating said visual schedule comprising said choices.

16. The system of claim 15, wherein said human useable interface comprises the ability to add a sequential instruction output.

17. The system of claim 16, wherein said sequential instruction output comprises video.

18. The system of claim 5, said method further comprising the step of providing an audio output based on said first input, wherein said audio output is chosen from a set of at least two different stored audio outputs relating to said first user input.

19. (canceled)

20. (canceled)

21. The system of claim 18, wherein said display is a visual schedule.

22. The system of claim 18 wherein said audio output is chosen from said stored audio outputs at random.

23. The system of claim 5, wherein said scene contains one or more of said user interface objects, said method further comprising the steps of
a) For certain of said one or more of said user interface objects, displaying the choice board;
b) For others of said one or more of said user interface objects, providing an output comprising a visual schedule comprising a series of choices corresponding to a series of smaller tasks wherein said smaller tasks, when performed in the order presented, result in the performance of said first larger task, and wherein said choices, upon actuation, visually depict that they have been completed.

24. The system of claim 23, wherein at least one of said series of choices comprises a visual representation having a first shade and a second shade, wherein said visual representation is represented in said first shade and said second shade, in proportion to an amount of time associated with said smaller task.

25. The system of claim 5 wherein said choice is displayed visually as a symbol from the group consisting of text, a graphic, and a photograph.

26. The system of claim 23, wherein at least one of said series of choices comprises a visual representation having a first shade and a second shade, wherein said visual representation is represented in said first shade and said second shade, in proportion to an amount of time associated with said smaller task.

27. The system of claim 23 further comprising a visual depiction of a reward for completing said first larger task.

28. The system of claim 23, wherein said method further comprises the steps of presenting a human useable interface for editing said visual depiction comprising the steps of:
a) choosing an additional object;
b) associating said object with said first larger task or a second larger task; and
c) associating at least one new smaller task with said first larger task or said second larger task.

29. The system of claim 23 further comprising machine readable instructions for providing a human useable interface for creating said visual schedule comprising said choices.

30. The system of claim 29, wherein said human useable interface comprises the ability to add a sequential instruction output.

31. The system of claim 30, wherein said sequential instruction output comprises video.
